(19) United States
(12) Patent Application Publication
(10) Pub. No.: US 2007/0082704 A1
(43) Pub. Date: Apr. 12, 2007

(54) Radio communication system, mobile terminal device, server device, memory card and computer-readable program

(76) Inventors: Toshihisa Nakano, Osaka (JP); Motoji Ohmori, Osaka (JP); Hiroshi Nishikawa, Kanagawa (JP)

Correspondence Address: WENDEROTH, LIND & PONACK L.L.P., 2033 K. STREET, NW, SUITE 800, WASHINGTON, DC, 20006, US

(21) Appl. No.: 10/576,695

(22) PCT Filed: Nov. 1, 2004
(86) PCT No.: PCT/JP04/16504

§ 371 Date: Apr. 21, 2006

(30) Foreign Application Priority Data
Oct. 30, 2003 (JP) 2003-369998

(51) Int. Cl. H04M 1/00

(52) U.S. Cl. 455/558; 455/550.1; 370/310

(57) ABSTRACT

A radio communication system includes a mobile terminal device to which a memory card is attached and a server device. The server device and the memory card transfer information to each other through the mobile terminal device by radio communication. This is achieved in the following manner. When receiving a start request from the server device, the mobile terminal device supplies power to the memory card. Furthermore, the mobile terminal device communicates with the server device, to prepare for information transfer to be performed between the server device and the memory card. After becoming able to operate, the memory card performs a boot operation. When completing the boot operation, the memory card starts information transfer with the server device through the mobile terminal device.

### TECHNICAL FIELD

The present invention relates to a radio communication system in which information is transferred by radio communication between a server device and a memory card through a mobile terminal device.

### BACKGROUND ART

An electronic fare collection system utilizing a noncontact IC card has recently been put into practical use in public transportation.

Such a noncontact IC card has functions as a commuter pass and a prepaid card.

To enter a station and get on a train, a user holds the noncontact IC card over an automatic ticket gate installed in the station. Thus, authentication is performed by radio communication between the automatic ticket gate and the noncontact IC card. If the authentication is successful, the automatic ticket gate opens to let the user into the station.

To exit a destination station, the user holds the noncontact IC card over an automatic ticket gate installed in the destination station. Thus, authentication is performed by radio communication between the automatic ticket gate and the noncontact IC card. If the user travels an extra distance which is not covered by the commuter pass function of the noncontact IC card, a fare adjustment operation is additionally performed by radio communication between the automatic ticket gate and the noncontact IC card.

If a fare adjustment operation is performed, the automatic ticket gate subtracts an amount of a fare for the travel of the extra distance, from an amount indicated by a prepaid account shown by the noncontact IC card.

Interface, March issue, 2003, CQPublishingCo. Ltd, p71-72 (non-patent document 1) discloses an example of information transfer performed for authentication and fare adjustment, between a noncontact IC card and an automatic ticket gate.

According to this technique, when detecting that a noncontact IC card is within a radio reach range, an automatic ticket gate transmits/receives various commands to/from the noncontact IC card. Thus, the automatic ticket gate confirms that the noncontact IC card has a function of a commuter pass, performs mutual authentication with the noncontact IC card, and reads/writes data including prepaid account information from/into the noncontact IC card.

However, it is under consideration that such a noncontact IC card is replaced with a mobile terminal such as a personal digital assistant (PDA) to which a memory card having functions such as authentication is attached.

This idea has the following advantages. Firstly, a user can buy a new mobile terminal without changing a memory card. Accordingly, it is not necessary to transfer information stored in an original memory card such as prepaid account information to a new memory card. Secondly, even if an authentication method, an encryption method and the like are leaked, it is only a memory card which needs to be replaced, not a mobile terminal.

Here, a mobile terminal such as a PDA is required to operate for long hours using a battery. Therefore, it is preferable that a mobile terminal supplies power to an attached memory card only when the power supply is necessary, in order to reduce power consumption.

According to this method, however, it takes a longer time for a user to go through an automatic ticket gate to exit a station, when compared with a case where a mobile terminal constantly supplies power to a memory card. This is because a boot operation of a memory card additionally needs to be performed after a mobile terminal starts supplying power to the memory card.

Furthermore, encryption performed by a memory card has become more complicated. This requires an increasingly longer time for operations, for example, fare adjustment, conducted between an automatic ticket gate and a mobile terminal to which a memory card is attached. As a result, it has become difficult to complete all of the necessary operations within a time period during which a user goes through an automatic ticket gate.

### DISCLOSURE OF THE INVENTION

In light of the above problem, an object of the present invention is to provide a radio communication system which enables operations including a fare adjustment operation and a boot operation of a memory card to be completed earlier.

The object can be achieved by a radio communication system including a server device and a mobile terminal device to which a memory card is attached. The server device, the mobile terminal device, and the memory card perform communication including a first procedure and a second procedure. Here, the server device transmits a start request to the mobile terminal device, where the start request requires the communication to be started. The mobile terminal device comprises: a receiving unit operable to receive the start request from the server device; an activating unit operable to activate the memory card, when the receiving unit receives the start request; and a first communication unit operable to, when the receiving unit receives the start request, perform the first procedure with the server device. The memory card comprises: a boot unit operable to perform a boot operation when the memory card is activated, where the boot operation is performed concurrently with the first procedure between the first communication unit and the server device; and a second communication unit operable to, when the boot unit completes the boot operation, perform the second procedure with the server device.

The object is also achieved by a mobile terminal device to which a memory card is attached. The mobile terminal device and a server device constitute a radio communication system. The mobile terminal device comprises: a receiving unit operable to receive a start request from the server device, where the start request requires the mobile terminal device, the server device, and the memory card to start communication including a plurality of procedures; an activating unit operable to activate the memory card, when the receiving unit receives the start request; and a communication unit operable to, when the receiving unit receives the start request, perform an initial procedure of the plurality of procedures with the server device.

According to this construction, when the mobile terminal device receives the start request from the server device, the first (initial) procedure is performed between the mobile terminal device and the server device concurrently with the boot operation of the memory card. This enables the communication to be completed earlier, when compared with a case where the communication is started after the boot operation of the memory card is completed.

Here, when the receiving unit receives the start request, the activating unit may supply power to the memory card.

Here, when the communication is completed, the activating unit may stop supplying power to the memory card.

According to this construction, when the mobile terminal device receives the start request from the server device, the mobile terminal device starts to supply power to the memory card. The initial procedure is performed between the mobile terminal device and the server device concurrently with the boot operation of the memory card. This enables the communication including the plurality of procedures to be completed earlier, when compared with a case where the communication is started after the boot operation of the memory card is completed. Thus, power consumption can be also reduced.

Here, the communication unit may notify the memory card of information obtained by performing the initial procedure.

According to this construction, the memory card acquires the information obtained by the initial procedure from the mobile terminal device, to perform the rest of the plurality of procedures with the server device. Thus, the rest of the plurality of procedures between the memory card and the server device can be performed based on the acquired information. As a result, various forms of communication can be realized.

Here, before the receiving unit receives the start request, the activating unit may supply power to the memory card, and stop supplying power on reception of an instruction by the communication unit, and before the receiving unit receives the start request and while the activating unit is supplying power to the memory card, the communication unit may obtain information necessary to perform the initial procedure, from the memory card, and then instruct the activating unit to stop supplying power to the memory card.

According to this construction, the mobile terminal device obtains the information necessary to perform the initial procedure in advance, from the memory card. Therefore, the initial procedure can be performed between the mobile terminal device and the server device using the obtained information, concurrently with the boot operation of the memory card. This enables the communication including the plurality of procedures to be completed earlier, when compared with a case where the communication is started after the boot operation of the memory card is completed.

Here, before the receiving unit receives the start request and while the activating unit is supplying power to the memory card, the communication unit may perform authentication with the memory card, and if the authentication is successful, the communication unit may obtain, from the memory card, the information necessary to perform the initial procedure, and then instruct the activating unit to stop supplying power.

According to this construction, the mobile terminal device obtains the information necessary to perform the initial procedure in advance, from the memory card, after performing the authentication with the memory card. Therefore, the initial procedure can be performed between the mobile terminal device and the server device using the obtained information, concurrently with the boot operation of the memory card. Thus, the necessary information can be prevented from being obtained by an illegal device. Furthermore, this enables the communication to be completed earlier, when compared with a case where the communication is started after the boot operation of the memory card is completed.

Here, the server device may be an automatic ticket gate installed at a train station, and the communication may be related to a fare adjustment operation.

According to this construction, when the mobile terminal device receives the start request from the automatic ticket gate, the initial procedure of the plurality of procedures that are related to a fare adjustment operation can be performed between the mobile terminal device and the automatic ticket gate concurrently with the boot operation of the memory card. This enables the communication to be completed earlier, when compared with a case where the communication is started after the boot operation of the memory card is completed.

Here, the server device may be a cash register installed at a shop, and the communication may be related to a payment for a purchase made at the shop.

According to this construction, when the mobile terminal device receives the start request from the cash register, the initial procedure of the plurality of procedures that are related to the payment can be performed between the mobile terminal device and the cash register concurrently with the boot operation of the memory card. This enables the communication to be completed earlier, when compared with a case where the communication is started after the boot operation of the memory card is completed.

The object is achieved by a mobile terminal device that has a module built-in. The mobile terminal device and a server device constitute a radio communication system. Here, the mobile terminal device comprises: a receiving unit operable to receive a start request from the server device, where the start request requires the mobile terminal device, the module, and the server device to start communication including a first procedure and a second procedure; an activating unit operable to activate the module, when the receiving unit receives the start request; and a first communication unit operable to, when the receiving unit receives the start request, perform the first procedure with the server device. The module comprises: a boot unit operable to, when the module is activated, perform a boot operation, where the boot operation is performed concurrently with the first procedure between the first communication unit and the server device; and a second communication unit operable to, when the boot unit completes the boot operation, perform the second procedure with the server device.

According to this construction, when the mobile terminal device receives the start request from the server device, the first procedure can be performed between the mobile terminal device and the server device concurrently with the boot operation of the module. This enables the communication including the first and second procedures to be completed earlier, when compared with a case where the communication is started after the boot operation of the module is completed.

Here, the second procedure by the second communication unit may include authentication.

According to this construction, when the mobile terminal device receives the start request from the server device, the first procedure can be performed between the mobile terminal device and the server device concurrently with the boot operation of the module. This enables the communication including the authentication to be completed earlier, when compared with a case where the communication is started after the boot operation of the module is completed.

Here, the module may be an LSI.

According to this construction, when the mobile terminal device receives the start request from the server device, the first procedure can be performed between the mobile terminal device and the server device concurrently with the boot operation of the LSI. This enables the communication including the authentication to be completed earlier, when compared with a case where the communication is started after the boot operation of the LSI is completed.

The object is achieved by a server device constituting a radio communication system together with a mobile terminal device to which a memory card is attached. The server device transmits a start request to the mobile terminal device to require the server device, the mobile terminal device, and the memory card to start communication including a plurality of procedures.

According to this construction, the server device can issue a trigger to the mobile terminal device for starting communication with the memory card.

The above object is achieved by a memory card attached to a mobile terminal device. The mobile terminal device activates the memory card when receiving a start request from a server device, where the start request requires the memory card, the mobile terminal device, and the server device to start communication including a first procedure and a second procedure. The memory card comprises: a boot unit operable to perform a boot operation when the memory card is activated, where the boot operation is performed concurrently with the first procedure between the mobile terminal device and the server device; and a communication unit operable to, when the boot unit completes the boot operation, perform the second procedure with the server device.

Here, the second procedure by the communication unit may include authentication.

According to this construction, when the mobile terminal device starts to supply power to the memory card, the first procedure can be performed between the mobile terminal device and the server device, concurrently with the boot operation of the memory card. This enables the communication including the first and second procedures to be completed earlier, when compared with a case where the communication is started after the boot operation of the module is completed.

The object is achieved by a computer-readable program applied to a mobile terminal device to which a memory card is attached. The mobile terminal device and a server device constitute a radio communication system. Here, the program causes a computer to perform steps of: receiving a start request from the server device, where the start request requires the mobile terminal device, the server device, and the memory card to start communication including a plurality of procedures; activating the memory card, when the start request is received; and performing an initial procedure of the plurality of procedures between the server device and the mobile terminal device, when the start request is received.

According to this construction, when the mobile terminal device receives the start request from the server device, the initial procedure is performed between the mobile terminal device and the server device concurrently with the boot operation of the memory card. This enables the communication including the plurality of procedures to be completed earlier, when compared with a case where the communication is started after the boot operation of the module is completed.

The above object is achieved by a computer-readable program applied to a memory card that is attached to a mobile terminal device. The mobile terminal device activates the memory card when receiving a start request from a server device, where the start request requires the memory card, the mobile terminal device, and the server device to start communication including a first procedure and a second procedure. Here, the program causes a computer to perform steps of: performing a boot operation when the memory card is activated, concurrently with the first procedure between the mobile terminal device and the server device; and performing the second procedure between the memory card and the server device, when the boot operation is completed.

According to this construction, when the mobile terminal device receives the start request from the server device, the first procedure is performed between the mobile terminal device and the server device concurrently with the boot operation of the memory card. This enables the communication including the first and second procedures to be completed earlier, when compared with a case where the communication is started after the boot operation of the memory card is completed.

### BRIEF DESCRIPTION OF THE DRAWINGS

FIG. 1 is a schematic view illustrating a radio communication system relating to the best embodiment of the present invention.

FIG. 2 illustrates information stored in a memory card.

FIG. 3 is a block diagram illustrating a construction of the radio communication system relating to the embodiment of the present invention.

FIG. 4 is a fare table showing a fare for a train travel between specific stations.

FIGS. 5A and 5B illustrate a flow chart illustrating a fare adjustment operation performed by the radio communication system.

### BEST MODE FOR CARRYING OUT THE INVENTION

1. Overview

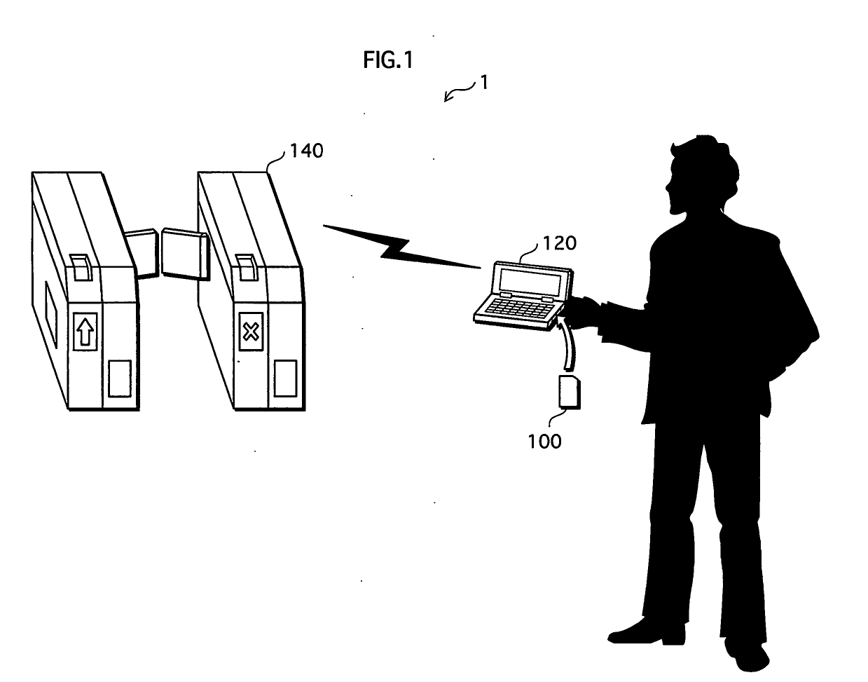

FIG. 1 is a schematic view illustrating a radio communication system 1 relating to the best embodiment of the present invention.

The radio communication system 1 is used for examining a ticket at a station of a railway company.

Here, each station of the railway company is associated with a particular station identifier, and provided with an automatic ticket gate.

A user takes a mobile terminal device 120 to use a train service provided by the railway company.

A memory card 100 is inserted into an insertion slot in the mobile terminal device 120. The memory card 100 is issued by the railway company.

By the insertion of the memory card 100, the mobile terminal device 120 has functions of a commuter pass and a prepaid card.

The memory card 100 is a storage medium including an IC.

The memory card 100 makes use of a radio communication function of the mobile terminal device 120, to perform authentication, encrypted communication, and prepaid account management with an automatic ticket gate.

In the present embodiment, radio communication is conducted in a frequency band of 13.56 MHz. The mobile terminal device 120 includes a battery, and supplies power to the memory card 100. Accordingly, the memory card 100 and the mobile terminal device 120 do not need to generate an electromotive force by radio communication, unlike a wireless IC tag and the like.

Here, radio communication can be conducted in a frequency band of other than 13.56 MHz.

The memory card 100 stores information relating to a payment, such as prepaid account information showing an amount of money the user can use.

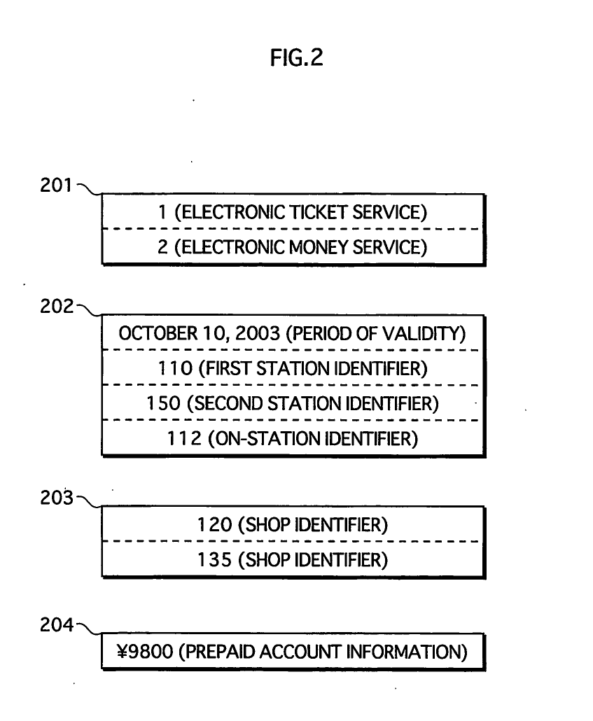

FIG. 2 illustrates information stored in the memory card 100.

The memory card 100 has a storage area for storing information.

The storage area is divided into areas 201, 202, 203 and 204 that are respectively identified by corresponding area identifiers.

Values of the area identifiers corresponding to the areas 201, 202, 203 and 204 are respectively one, two, three and four.

In the present embodiment, the memory card 100 can provide an electronic ticket service and an electronic money service.

The electronic ticket service and the electronic money service are respectively identified by service identifiers of one and two.

The area 201 stores the service identifiers of the services the memory card 100 can provide.

The area 202 stores information relating to the electronic ticket service.

In detail, the area 202 stores validity information, a first station identifier, a second station identifier, and an on-station identifier.

The validity information shows a period of validity of the commuter pass function, and indicates Oct. 10, 2003, for example.

The first station identifier and the second station identifier identify stations between which the user can travel without paying an extra fare, when using the commuter pass function.

The on-station identifier identifies a station at which the user gets on a train.

The on-station identifier is written by an automatic ticket gate installed in the station at which the user gets on the train, by radio communication.

The area 203 stores information relating to the electronic money service, specifically, a shop identifier.

A shop identifier identifies a shop at which the user can do shopping using the memory card 100.

The area 204 stores information relating to a payment, specifically, prepaid account information.

The prepaid account information shows an amount of money the user can use.

Here, the memory card 100 receives a power supply from the mobile terminal device 120, and can operate only while receiving a power supply.

The memory card 100 makes use of radio communication performed between the mobile terminal device 120 and an automatic ticket gate.

To enter a station and get on a train, the user holds the mobile terminal device 120 close to an automatic ticket gate installed in the station.

The automatic ticket gate communicates with the memory card 100 through the mobile terminal device 120. Thus, the automatic ticket gate writes a station identifier of this station into the area 202 in the memory card 100, and opens.

The user goes through the automatic ticket gate to enter the station, gets on the train, travels to a destination station, and gets off the train at the destination station.

To exit the destination station, the user holds the mobile terminal device 120 close to an automatic ticket gate 140 which is installed in the destination station.

The automatic ticket gate 140 performs a fare adjustment operation with the memory card 100 through the mobile terminal device 120, if necessary.

The fare adjustment operation is described later.

The mobile terminal device 120 supplies power to the memory card 100.

2. Construction

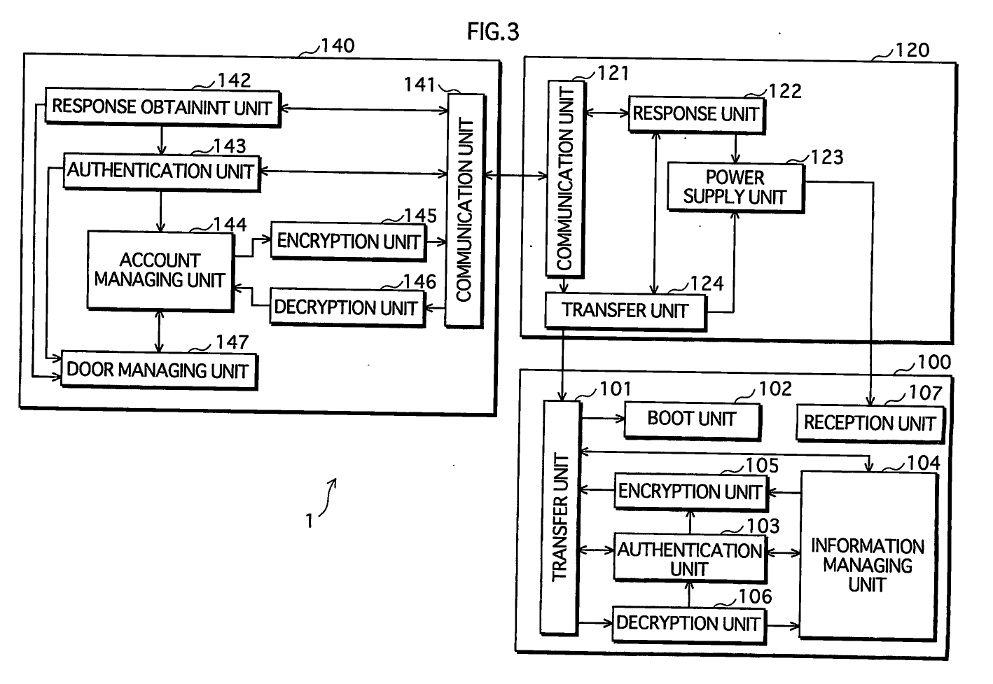

FIG. 3 is a block diagram illustrating a construction of the radio communication system 1 relating to the embodiment of the present invention.

2.1. The Memory Card 100

The memory card 100 is specifically constituted by a CPU, a ROM, a RAM and the like. Functions of the memory card 100 are realized in such a manner that the CPU operates in accordance with a computer program stored in the ROM.

A transfer unit 101 transmits/receives information to/from the mobile terminal device 120.

A boot unit 102 performs a boot operation of the memory card 100.

The boot operation is an initial operation performed when the mobile terminal device 120 starts supplying power to the memory card 100. The boot operation includes initialization of the RAM and a register, and loading of a program.

The memory card 100 operates only while receiving a power supply from the mobile terminal device 120. Here, the mobile terminal device 120 supplies power to the memory card 100 only when the power supply is necessary, thereby reducing power consumption.

When completing the boot operation, the boot unit 102 outputs a boot completion notice to the mobile terminal device 120 through the transfer unit 101.

An authentication unit 103 performs mutual authentication with the automatic ticket gate 140 through the transfer unit 101 and the mobile terminal device 120.

The authentication unit 103 prestores a secret key.

This secret key is identical to a secret key stored in the automatic ticket gate 140.

Here, the mutual authentication is conducted using three-pass mutual authentication defined by ISO/IEC 9798-3.

According to the three-pass mutual authentication, two parties each judge whether the other party has an identical key by encryption and decryption of a random number.

The three-pass mutual authentication is not explained in detail in the present description.

When the mutual authentication is successful, the authentication unit 103 sends an authentication completion notice to an information managing unit 104.

The information managing unit 104 stores information indicating the functions of the memory card 100, as a commuter pass and a prepaid card (shown in FIG. 2).

Here, the information managing unit 104 outputs information stored in each of the areas 201 to 204 in response to an area read request from the automatic ticket gate 140. Also, the information managing unit 104 stores information into a corresponding one of the areas 201 to 204 in response to an area write request from the automatic ticket gate 140.

An area read request includes an area identifier of an area in which requested information is stored.

An area write request includes a value to be written and an area identifier of an area to which the value is to be written.

Here, the area 201 is used irrespective of whether the information managing unit 104 receives an authentication completion notice from the authentication unit 103.

When receiving a service read request, the information managing unit 104 transmits a service read response which includes information stored in the area 201, to a source which has issued the service read request.

A service read response includes a service identifier stored in the area 201.

In the present embodiment, a service read response from the information managing unit 104 includes values of one and two.

A source which issues a service read request is mainly the mobile terminal device 120 in the present embodiment.

The information managing unit 104 rejects an area read request for the areas 202 to 204, before receiving an authentication completion notice from the authentication unit 103.

Furthermore, the information managing unit 104 outputs an operation completion notice to the mobile terminal device 120, when the memory card 100 and the automatic ticket gate 140 completes a fare adjustment operation.

Here, the information managing unit 104 recognizes that a fare adjustment operation is completed, when the prepaid account information is updated.

An encryption unit 105 encrypts information input from the information managing unit 104 using the secret key stored in the authentication unit 103, and outputs the encrypted information to the transfer unit 101.

A decryption unit 106 decrypts information from the transfer unit 101 using the secret key, and outputs the decrypted information to the information managing unit 104.

A reception unit 107 receives a power supply from the mobile terminal device 120.

When the reception unit 107 receives a power supply, all of the necessary components of the memory card 100 are supplied with power.

2.2. Mobile Terminal Device 120

The mobile terminal device 120 is constituted by a CPU, a ROM, a RAM and the like. Functions of the mobile terminal device 120 are realized in such a manner that the CPU operates in accordance with a computer program stored in the ROM.

A communication unit 121 performs radio communication.

The communication unit 121 transfers received information to a corresponding destination.

A response unit 122 reads a service identifier from the memory card 100, and stores the read service identifier.

In detail, the response unit 122 transmits a service read request to the memory card 100 through a transfer unit 124, and receives a service read response.

The service read response includes the service identifiers which indicate the services the memory card 100 can provide.

The response unit 122 stores the received service identifiers.

When receiving the service read response, the response unit 122 sends a power supply stop instruction to a power supply unit 123.

When receiving a start request from the automatic ticket gate 140, the response unit 122 sends a power supply start instruction to the power supply unit 123, and transmits an acknowledgment to the automatic ticket gate 140.

The response unit 122 receives a service confirmation request including a service identifier, from the automatic ticket gate 140.

If any of the service identifiers stored in the response unit 122 as a result of receiving a service read response is identical to the service identifier included in the received service confirmation request, the response unit 122 transmits an affirmative service confirmation response showing presence of a requested service to the automatic ticket gate 140. If not, the response unit 122 transmits a negative service confirmation response showing absence of the requested service.

When receiving a power supply start instruction, the power supply unit 123 starts supplying power to the memory card 100. When receiving a power supply stop instruction, the power supply unit 123 stops supplying power to the memory card 100.

The transfer unit 124 transmits/receives information to/from the memory card 100.

When receiving an area write response from the memory card 100, the transfer unit 124 notifies the response unit 122 of the reception of the area write response. The response unit 122 then sends a power supply stop instruction to the power supply unit 123.

2.3. Automatic Ticket Gate 140

The automatic ticket gate 140 is a computer system constituted by a CPU, a ROM, a RAM, a door that limits entrance/exit to/from a station, and the like. Functions of the automatic ticket gate 140 are realized in such a manner that the CPU operates in accordance with a computer program stored in the ROM.

A communication unit 141 performs radio communication.

A response obtaining unit 142 issues a start request at regular time intervals through the communication unit 141.

If the mobile terminal device 120 is within a radio reach range of the automatic ticket gate 140, the mobile terminal device 120 transmits an acknowledgment to the automatic ticket gate 140 in reply to the start request from the response obtaining unit 142.

When receiving the acknowledgment, the response obtaining unit 142 suspends transmission of a start request until an operation by the automatic ticket gate 140 is ended.

Furthermore, when receiving the acknowledgment from the mobile terminal device 120, the response obtaining unit 142 transmits a service confirmation request to the mobile terminal device 120 to examine whether the memory card 100 can provide a particular service.

Here, the service confirmation request includes a service identifier.

It should be noted that a service identifier of one shows an electronic ticket service relating to the automatic ticket gate 140.

The response obtaining unit 142 receives a service confirmation response from the mobile terminal device 120 in reply to the transmitted service confirmation request.

The service confirmation response is either affirmative or negative, reflecting the services the memory card 100 can provide.

When the received service confirmation response is affirmative, the response obtaining unit 142 outputs an authentication instruction to an authentication unit 143. When the received service confirmation response is negative, the response obtaining unit 142 outputs a closing instruction to a door managing unit 147.

When receiving the authentication instruction from the response obtaining unit 142, the authentication unit 143 performs mutual authentication with the memory card 100 through the communication unit 141 and the mobile terminal device 120.

The mutual authentication is conducted using the above-mentioned three-pass mutual authentication.

If the mutual authentication is successful, the authentication unit 143 sends an authentication completion notice to an account managing unit 144.

If the mutual authentication fails, the authentication unit 143 outputs a closing instruction to the door managing unit 147.

The account managing unit 144 stores station identifying information showing a station at which the automatic ticket gate 140 is installed.

Here, when receiving the authentication completion notice, the account managing unit 144 starts fare examination.

To be specific, the account managing unit 144 transmits an area read request including the area identifiers of two and four, to the memory card 100 through the mobile terminal device 120.

The account managing unit 144 receives an area read response from the memory card 100 through the mobile terminal device 120.

The received area read response includes the validity information, the first station identifier, the second station identifier and the on-station identifier read from the area 202, and the prepaid account information read from the area 204.

The account managing unit 144 judges whether the value of each of the on-station identifier and a station identifier stored in the account managing unit 144 (which is to say, a station identifier of a station at which the user gets off the train, hereinafter referred to as an off-station identifier) falls within a range specified by the values of the first station identifier and the second station identifier. If the judgment is affirmative, the account managing unit 144 determines that the user needs to pay no extra fare. If the judgment is negative, the account managing unit 144 determines that the user needs to pay an extra fare.

For example, it is assumed that the value of the first station identifier is 110 and the value of the second station identifier is 150. Here, if the value of the on-station identifier is 112 and the value of the off-station identifier is 130, both of the values of 112 and 130 fall within the range between 110 and 150. As a result, the account managing unit 144 judges that the user needs to pay no extra fare.

However, if the value of the on-station identifier is 180 and the value of the off-station identifier is 130, the value of 180 does not fall within the range between 110 and 150. Consequently, the account managing unit 144 judges that the user needs to pay an extra fare.

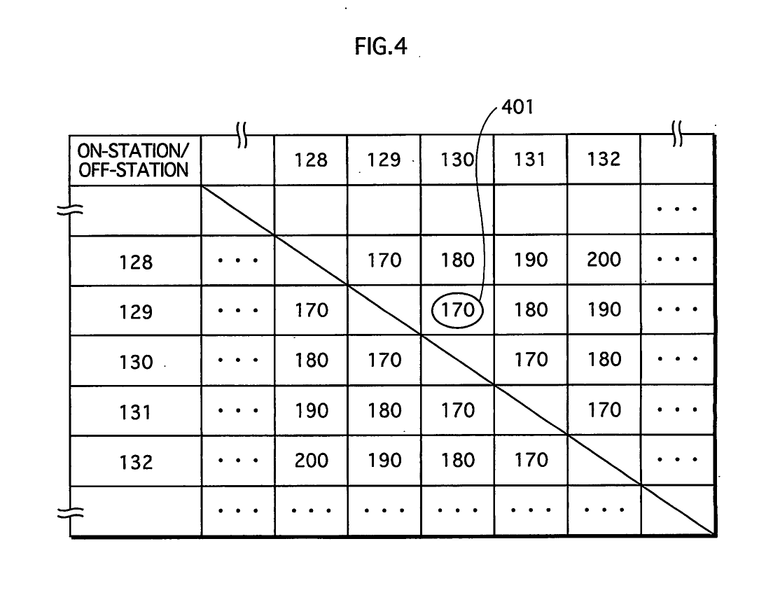

FIG. 4 is a fare table showing a fare for a travel between specific two stations.

For example, the user needs to pay a fare of 170 for a train travel between a station with a station identifier of 129 and a station with a station identifier of 130 (see section 401).

Storing this fare table, the account managing unit 144 determines an extra fare, with reference to station identifiers of stations specifying an extra distance.

If the user is judged to need to pay an extra fare, the account managing unit 144 determines the extra fare with reference to the fare table shown in FIG. 4.

The account managing unit 144 then subtracts an amount of the determined extra fare from an amount shown by the prepaid account information. The account managing unit 144 then transmits an area write request including the prepaid account information as a result of the subtraction and the area identifier of four, to the memory card 100 through the mobile terminal device 120.

Here, if the prepaid account information shows a negative amount as a result of the subtraction, the account managing unit 144 does not transmit an area write request. Instead, the account managing unit 144 sends a closing instruction to the door managing unit 147.

Also, the account managing unit 144 receives an area write response from the memory card 100 through the mobile terminal device 120.

When receiving the area write response, the account managing unit 144 sends an opening instruction to the door managing unit 147.

Here, if the user is judged to need to pay no extra fare, the account managing unit 144 sends an opening instruction to the door managing unit 147. The door managing unit 147 opens the door.

3. Operation

The following part describes an operation performed by the radio communication system 1.

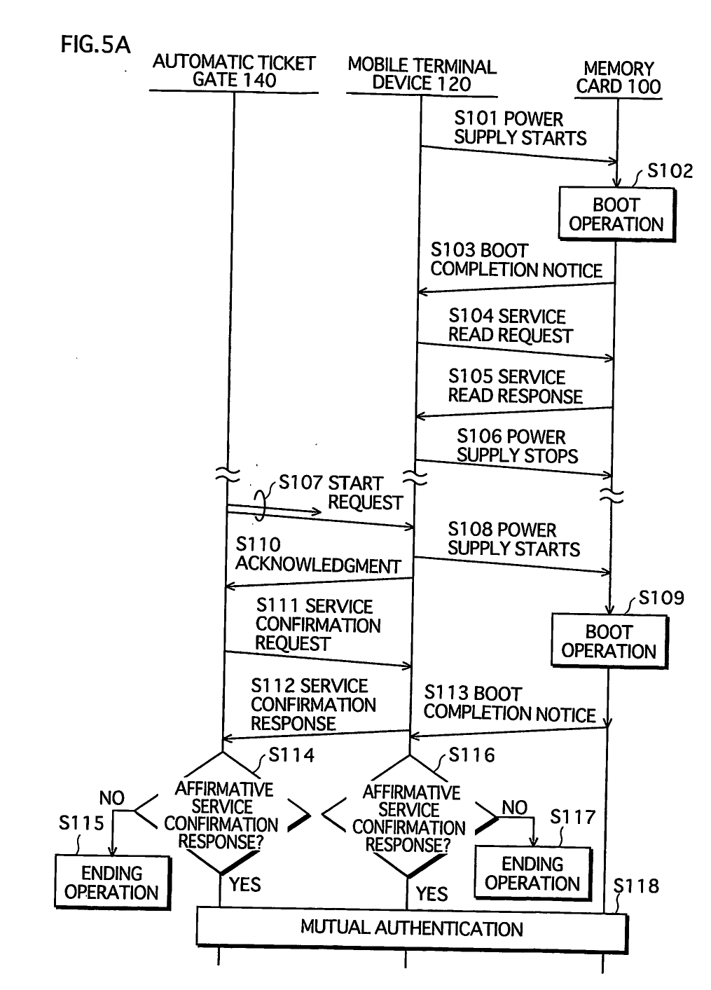

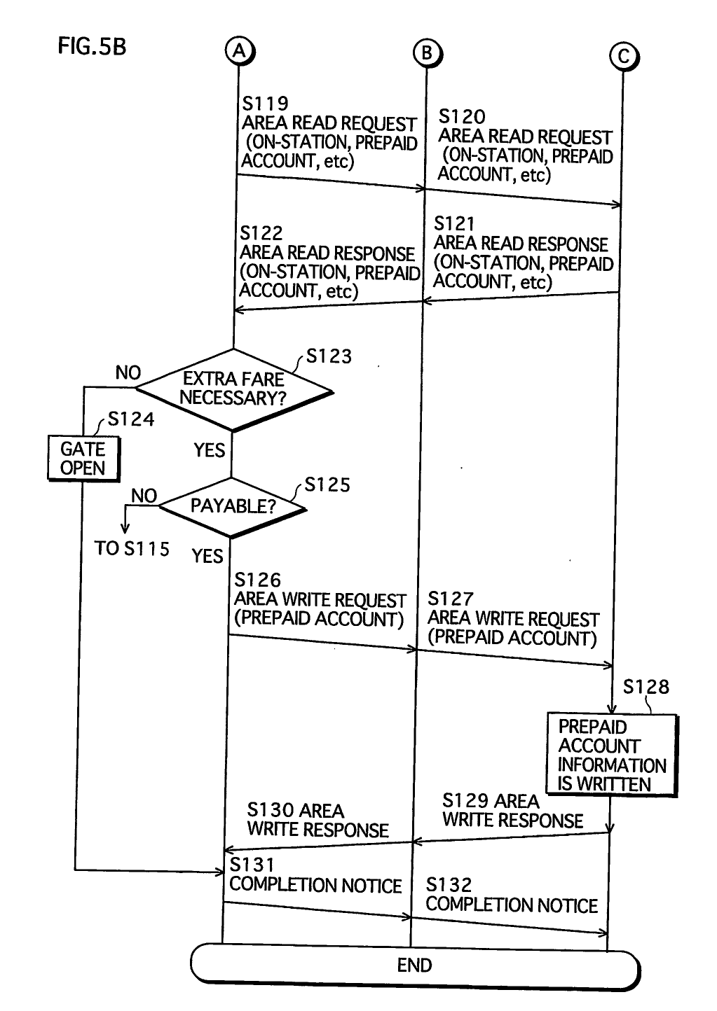

FIGS. 5A and 5B illustrate a flow chart illustrating the operation performed by the radio communication system 1.

It should be noted that a procedure of steps S101 to S106 needs to be performed before an operation which is to be conducted at a station where the user gets off the train (i.e. the station in which the automatic ticket gate 140 is installed), but may not be performed at the station where the user gets off the train.

It is a procedure starting from a step S107 which is performed at the station at which the user gets off the train.

Here, it is assumed that the step S107 is performed after the user has traveled to the station at which the user gets off.

The mobile terminal device 120 supplies power to the memory card 100 (step S101).

Because of the power supply, the memory card 100 performs a boot operation (step S102).

When completing the boot operation, the memory card 100 transmits a boot completion notice to the mobile terminal device 120 (step S103).

When receiving the boot completion notice, the mobile terminal device 120 transmits a service read request to the memory card 100 (step S104).

The memory card 100 transmits a service read response including all of the service identifiers stored in the area 201 to the mobile terminal device 120 (step S105).

The mobile terminal device 120 stores the service identifiers included in the received service read response, and then stops supplying power to the memory card 100 (step S106).

Here, the automatic ticket gate 140 issues a start request at regular time intervals (e.g. 20 ms) (step S107).

When receiving a start request issued by the automatic ticket gate 140, the mobile terminal device 120 starts supplying power to the memory card 100 (step S108).

Also, the mobile terminal device 120 suspends reception of a start request.

The memory card 100 performs a boot operation (step S109).

The mobile terminal device 120 transmits an acknowledgment in reply to the start request received in the step S108. The automatic ticket gate 140 receives the acknowledgment (step S110).

Here, the automatic ticket gate 140 suspends issuance of a start request.

When receiving the acknowledgment, the automatic ticket gate 140 transmits a service confirmation request to the mobile terminal device 120 (step S111).

The mobile terminal device 120 judges whether a service identifier included in the received service confirmation request matches any of the service identifiers stored in the mobile terminal device 120 in the step S106. If the judgment is affirmative, the mobile terminal device 120 transmits an affirmative service confirmation response. If the judgment is negative, the mobile terminal device 120 transmits a negative service confirmation response (step S112).

The automatic ticket gate 140 receives a service confirmation response.

Here, when completing the boot operation performed in the step S109, the memory card 100 transmits a boot completion notice to the mobile terminal device 120 (step S113).

The automatic ticket gate 140 examines whether the received service confirmation response is affirmative or negative (step S114). In the case of a negative service confirmation response (step S114:NO), the automatic ticket gate 140 closes, and restarts issuance of a start request (step S115).

In the case of an affirmative service confirmation response (step S114:YES), the automatic ticket gate 14 0 performs mutual authentication (step S118).

If the mobile terminal device 120 transmits a negative service confirmation response in the step S112 (step S116:NO), the mobile terminal device 120 restarts reception of a start request when a predetermined time (approximately 20 seconds here) has elapsed (step S117).

If the mobile terminal device 120 transmits an affirmative service confirmation response in the step S112 (step S116:YES), the mobile terminal device 120 relays the mutual authentication between the memory card 100 and the automatic ticket gate 140 (step S118).

The memory card 100 performs the mutual authentication with the automatic ticket gate 140 through the mobile terminal device 120 (step S118).

If the mutual authentication fails, the automatic ticket gate 140, the memory card 100 and the mobile terminal device 120 perform the following operations.

The automatic ticket gate 140 closes, and restarts issuance of a start request.

The memory card 100 transmits a notice of the failure of the mutual authentication to the mobile terminal device 120.

The mobile terminal device 120 receives the notice of the failure of the mutual authentication. After this, when a predetermined time (approximately 20 seconds here) has elapsed, the mobile terminal device 120 restarts reception of a start request, and stops supplying power to the memory card 100.

If the mutual authentication is successful, the automatic ticket gate 140 transmits an area read request including the area identifiers of two and four, to the memory card 100 through the mobile terminal device 120 (steps S119 and S120).

The memory card 100 transmits an area read response to the automatic ticket gate 140 through the mobile terminal device 120 (steps S121 and S122). The area read response includes the information stored in the area 202 specified by the area identifier of two and the prepaid account information stored in the area 204 specified by the area identifier of four.

The automatic ticket gate 140 judges whether the user needs to pay an extra fare, with reference to the first station identifier, the second station identifier, the on-station identifier, and the off-station identifier which is the station identifier of the station in which the automatic ticket gate 140 is installed (step S123). If the user is judged to need to pay no extra fare (step S123: NO), the automatic ticket gate 140 opens (step S124).

If the user is judged to need to pay an extra fare (step S123:YES), the automatic ticket gate 140 calculates the extra fare, and judges whether an amount of the calculated extra fare is lower than an amount shown by the prepaid account information read from the memory card 100 (step S125).

When the amount of the calculated extra fare is higher (step S125: NO), the automatic ticket gate 140 performs the ending operation conducted in the step S115.

When the amount of the calculated extra fare is lower (step S125:YES), the automatic ticket gate 140 subtracts the amount of the extra fare from the amount shown by the prepaid account information received in the step S122. The automatic ticket gate 140 then transmits an area write request to the memory card 100 through the mobile terminal device 120 (steps S126 and S127). The area write request includes the prepaid account information as a result of the subtraction and the area identifier of four.

The memory card 100 writes the prepaid account information included in the received area write request, into the area 204 specified by the area identifier of four (step S128).

The memory card 100 transmits an area write response to the automatic ticket gate 140 through the mobile terminal device 120 (steps S129 and S130).

When receiving the area write response, the automatic ticket gate 140 opens, transmits a completion notice to the mobile terminal device 120, and restarts issuance of a start request (step S131).

When receiving the completion notice from the automatic ticket gate 140, the mobile terminal device 120 stops supplying power to the memory card 100, and resumes reception of a start request when a predetermined time has elapsed (step S132).

4. Modification Examples

The present invention is not limited to the above-described embodiment, and includes the following modifications.

(1) According to the above embodiment, it is the automatic ticket gate 140 which judges whether the user needs to pay an extra fare in the step S12 3. However, this judgment may be made by the memory card 100.

If such is the case, the fare table showing correspondence between a travel distance and a fare is stored in the information managing unit 104.

(2) According to the above embodiment, the radio communication system 1 is, as an example, used by a railway company. However, the radio communication system 1 may be used in a shop such as a convenience store.

In such a case, the automatic ticket gate 140 is replaced with a cash register that calculates a total of prices of one or more goods the user is going to purchase, and requires the mobile terminal device 120 to make a payment.

The cash register may have the same construction as the automatic ticket gate 140, but does not need the door managing unit 147.

An account managing unit of the cash register adds up the prices of one or more goods the user is going to purchase, and requires the mobile terminal device 120 and the memory card 100 to make a payment.

The automatic ticket gate 140 judges whether the user needs to make a payment because of, for example, an extra travel which is not covered by the memory card 100. In the case of the cash register, however, the user always makes a payment.

(3) According to the above embodiment, the memory card 100 is attached to the mobile terminal device 120, to be used. Instead of the memory card 100 which is a portable medium, a module such as an LSI may be built into the mobile terminal device 120.

Here, the power supply unit 123 in the mobile terminal device 120 controls a power supply to the built-in module in the same manner as controlling a power supply to the memory card 100.

(4) According to the above embodiment, the memory card 100 is attached to the mobile terminal device 120, to be used. Instead of the memory card 100 which has a relatively large storage area, an IC card which has a small storage area of a few bytes and an IC may be used.

Here, the power supply unit 123 in the mobile terminal device 120 controls a power supply to the IC card in the same manner as controlling a power supply to the memory card 100.

(5) According to the embodiment, as an example, the mobile terminal device 120 supplies power to the memory card 100 to activate the memory card 100, and stops supplying power to the memory card 100 to deactivate the memory card 100. This construction may be modified as follows.

The memory card 100 may operate in one of a normal mode and a secure mode. When the mobile terminal device 120 receives a start request issued by the automatic ticket gate 140, the mobile terminal device 120 may instruct the memory card to operate in the secure mode. If such is the case, communication including transmission of a service confirmation request and a service confirmation response is performed between the mobile terminal device 120 and the automatic ticket gate 140 concurrently with a switching operation of the memory card 100 from the normal mode to the secure mode.

(6) The present invention may be a method described in the embodiment, a computer program realizing the method using a computer, or digital signals representing the computer program.

The present invention may be a computer-readable storage medium such as a flexible disc, a hard disc, a CD-ROM, an MO, a DVD, a DVD-ROM, a DVD-RAM, a Blu-ray disc (BD), a semiconductor memory or the like storing the computer program or the digital signals. Alternatively, the present invention may be the computer program or the digital signals in a state of being stored in the above-mentioned computer-readable storage medium.

The present invention may be transmission of the computer program or the digital signals through a network, such as a telecommunication line, a wireless or wired network, and the Internet.

The present invention may be a computer system including a microprocessor and a memory storing the computer program. Here, the microprocessor may operate in accordance with the computer program.

The computer program or the digital signals may be executed in a different independent computer system. If such is the case, the computer program or the digital signals may be stored in the above-mentioned computer-readable storage medium, and then transported. Alternatively, the computer program or the digital signals may be transmitted through the above-mentioned network.

(7) The above-described embodiment may be combined with any of the modification examples.

### INDUSTRIAL APPLICABILITY

The present invention can be used as a fundamental technology for an electronic fare collection system utilized in public transportation, a shop or the like. Here, necessary components such as a memory card, a mobile terminal device, a server device and a program are produced and sold by a manufacturer of information and telecommunication devices.

1. A radio communication system including a server device and a mobile terminal device to which a memory card is attached, the server device, the mobile terminal device, and the memory card performing communication including a first procedure and a second procedure,
the server device transmitting a start request to the mobile terminal device, the start request requiring the communication to be started,
the mobile terminal device comprising:
a receiving unit operable to receive the start request from the server device;
an activating unit operable to activate the memory card, when the receiving unit receives the start request; and
a first communication unit operable to, when the receiving unit receives the start request, perform the first procedure with the server device, and
the memory card comprising:
a boot unit operable to perform a boot operation when the memory card is activated, the boot operation being performed concurrently with the first procedure between the first communication unit and the server device; and
a second communication unit operable to, when the boot unit completes the boot operation, perform the second procedure with the server device.

2. A mobile terminal device to which a memory card is attached, the mobile terminal device and a server device constituting a radio communication system, the mobile terminal device comprising:
a receiving unit operable to receive a start request from the server device, the start request requiring the mobile terminal device, the server device, and the memory card to start communication including a plurality of procedures;
an activating unit operable to activate the memory card, when the receiving unit receives the start request; and
a communication unit operable to, when the receiving unit receives the start request, perform an initial procedure of the plurality of procedures with the server device.

3. The mobile terminal device of claim 2, wherein
when the receiving unit receives the start request, the activating unit supplies power to the memory card.

4. The mobile terminal device of claim 3, wherein
when the communication is completed, the activating unit stops supplying power to the memory card.

5. The mobile terminal device of claim 3, wherein
the communication unit notifies the memory card of information obtained by performing the initial procedure.

6. The mobile terminal device of claim 2, wherein
before the receiving unit receives the start request, the activating unit supplies power to the memory card, and stops supplying power on reception of an instruction by the communication unit, and
before the receiving unit receives the start request and while the activating unit is supplying power to the memory card, the communication unit obtains information necessary to perform the initial procedure, from the memory card, and then instructs the activating unit to stop supplying power to the memory card.

7. The mobile terminal device of claim 6, wherein
before the receiving unit receives the start request and while the activating unit is supplying power to the memory card, the communication unit performs authentication with the memory card, and
if the authentication is successful, the communication unit obtains, from the memory card, the information necessary to perform the initial procedure, and then instructs the activating unit to stop supplying power.

8. The mobile terminal device of claim 6, wherein
the server device is an automatic ticket gate installed at a train station, and
the communication is related to a fare adjustment operation.

9. The mobile terminal device of claim 6, wherein
the server device is a cash register installed at a shop, and
the communication is related to a payment for a purchase made at the shop.

10. A mobile terminal device that has a module built-in, the mobile terminal device and a server device constituting a radio communication system, the mobile terminal device comprising:
a receiving unit operable to receive a start request from the server device, the start request requiring the mobile terminal device, the module, and the server device to start communication including a first procedure and a second procedure;
an activating unit operable to activate the module, when the receiving unit receives the start request; and
a first communication unit operable to, when the receiving unit receives the start request, perform the first procedure with the server device, and
the module comprising:
a boot unit operable to, when the module is activated, perform a boot operation, the boot operation being performed concurrently with the first procedure between the first communication unit and the server device; and
a second communication unit operable to, when the boot unit completes the boot operation, perform the second procedure with the server device.

11. The mobile terminal device of claim 10, wherein
the second procedure by the second communication unit includes authentication.

12. The mobile terminal device of claim 11, wherein
the module is an LSI.

13. A server device constituting a radio communication system together with a mobile terminal device to which a memory card is attached, wherein
the server device transmits a start request to the mobile terminal device to require the server device, the mobile terminal device, and the memory card to start communication including a plurality of procedures.

14. A memory card attached to a mobile terminal device, the mobile terminal device activating the memory card when receiving a start request from a server device, the start request requiring the memory card, the mobile terminal device, and the server device to start communication including a first procedure and a second procedure, the memory card comprising:
a boot unit operable to perform a boot operation when the memory card is activated, the boot operation being performed concurrently with the first procedure between the mobile terminal device and the server device; and
a communication unit operable to, when the boot unit completes the boot operation, perform the second procedure with the server device.

15. The memory card of claim 14, wherein
the second procedure by the communication unit includes authentication.

16. A computer-readable program applied to a mobile terminal device to which a memory card is attached, the mobile terminal device and a server device constituting a radio communication system, the program causing a computer to perform steps of:
receiving a start request from the server device, the start request requiring the mobile terminal device, the server device, and the memory card to start communication including a plurality of procedures;
activating the memory card, when the start request is received; and
performing an initial procedure of the plurality of procedures between the server device and the mobile terminal device, when the start request is received.

17. A computer-readable program applied to a memory card that is attached to a mobile terminal device, the mobile terminal device activating the memory card when receiving a start request from a server device, the start request requiring the memory card, the mobile terminal device, and the server device to start communication including a first procedure and a second procedure, the program causing a computer to perform steps of:
performing a boot operation when the memory card is activated, concurrently with the first procedure between the mobile terminal device and the server device; and
performing the second procedure between the memory card and the server device, when the boot operation is completed.
